(19) United States
(12) Patent Application Publication
(10) Pub. No.: US 2004/0032993 A1
(43) Pub. Date: Feb. 19, 2004

(54) Method for producing loop handle shopping bags

(76) Inventor: Konrad Tetenborg, Lengerich (DE)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/222,986

(22) Filed: Aug. 19, 2002

(51) Int. Cl. B65D 33/06; B31B 1/86

(52) U.S. Cl. 383/17; 493/226

(57) ABSTRACT

For the production of loop handle shopping bags based on semi-tube sheeting consisting of thermoplastic plastic, an edge strip of the semi-tube sheeting is folded onto itself and reinforcement warps, consisting of a weld-friendly thermoplastic plastic that provides a good weld, are attached on the interior sides of the edge areas by means of glueing or welding at a distance corresponding to the width of the shopping bags to be produced.

Subsequently, the edge strip is folded back so that the added reinforcement warps are positioned back-to-back. Double-layer handle strips are positioned in a U-shape and placed between the reinforcement warps with their end areas of the free shanks, and welded together with the edge areas through the reinforcement warps between welding devices. The shopping bags are then separated from the semi-tube sheeting by means of separating weld seams.

The invention relates to a method for producing loop handle shopping bags based on a tube sheeting consisting of thermoplastic plastic that is preferably equipped with a bottom fold.

Methods of this type are known.

In a method for producing loop handle shopping bags consisting of thermoplastic plastic known from DE 197 48 771 A1, the carrying handles embodied as handle loops are folded toward the interior and connected to the respective side wall on the edge areas of the bag side walls by means of welding or glueing.

In a method for producing loop handle shopping bags from a continuous feed double-layer thermoplastic plastic foil sheeting known from DE 99 24 626 A1, its edge areas are folded over by 180° on one side for attaching the shanks of the handle strips, and folded back congruently after attaching the handle strips. These known methods for producing loop handle shopping bags require that the edge areas of the shopping bags must be folded over for the reinforcement of the edges, which causes an increased consumption of plastic foil.

The shaping of U-shaped loop handles from a strip separated from plastic sheeting is known, for instance, from DE 20 12 084 A1 and DE 22 25 671 A1.

It is the task of the invention to recommend a method according to which loop handle shopping bags can be produced in a simple and cost-effective manner.

According to the invention, this task is solved by the characteristics listed in claim 1.

The inventive method can be performed in a material-saving manner, as the edge or hem fold can be omitted. The glued on, or welded on reinforcement warp can be freely chosen in its thickness and foil composition. It consists of a very weld-friendly warp foil that leads to a shorter welding time of the handle loop, and therefore to an increased production performance. The loop handle shopping bag produced according to the inventive method has a good appearance, because an existing imprint is not interrupted by a weld seam, and no wrinkling occurs due to the shrinking of the weld seams.

The formation of loop handles consisting of plastic strips that are positioned back-to-back, and the welding on of the reinforcement warp onto the interior sides of the plastic semi-tube sheeting edges can also be performed according to the description provided in DE 195 02 228 A1. Instead of a plate or a separating plate, a heatable crimper may also be inserted as an abutment between the welding areas of the loop handle shanks.

The invention further relates to shopping bags that have been produced according to the inventive method.

An embodiment example of the invention is described in further detail according to the drawing as follows. It shows

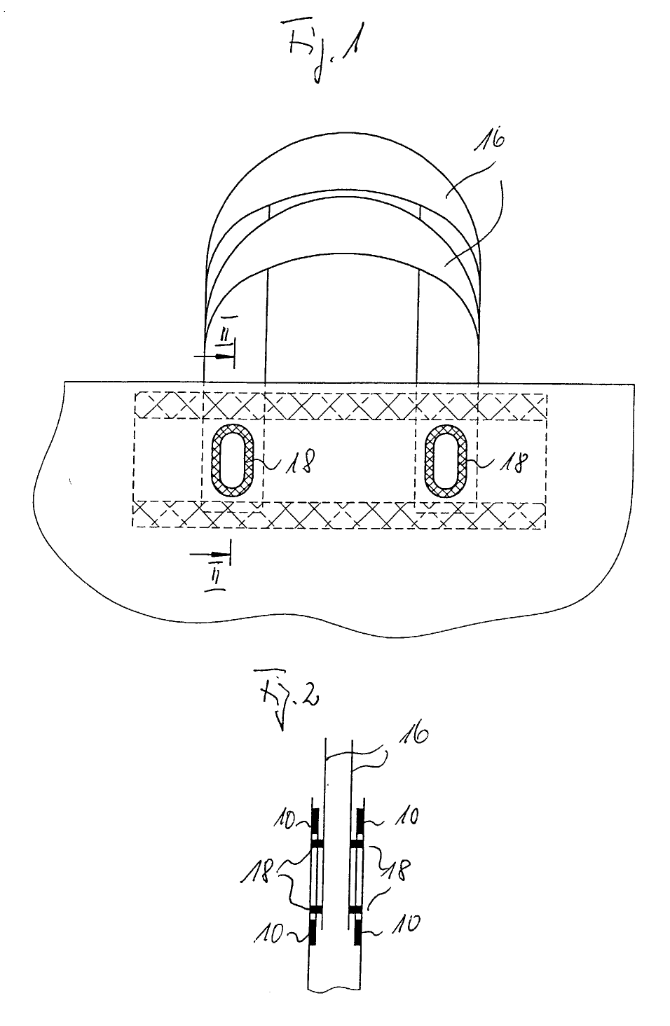

FIG. 1 a side view of the handle area of a loop handle shopping bag produced according to the inventive method,

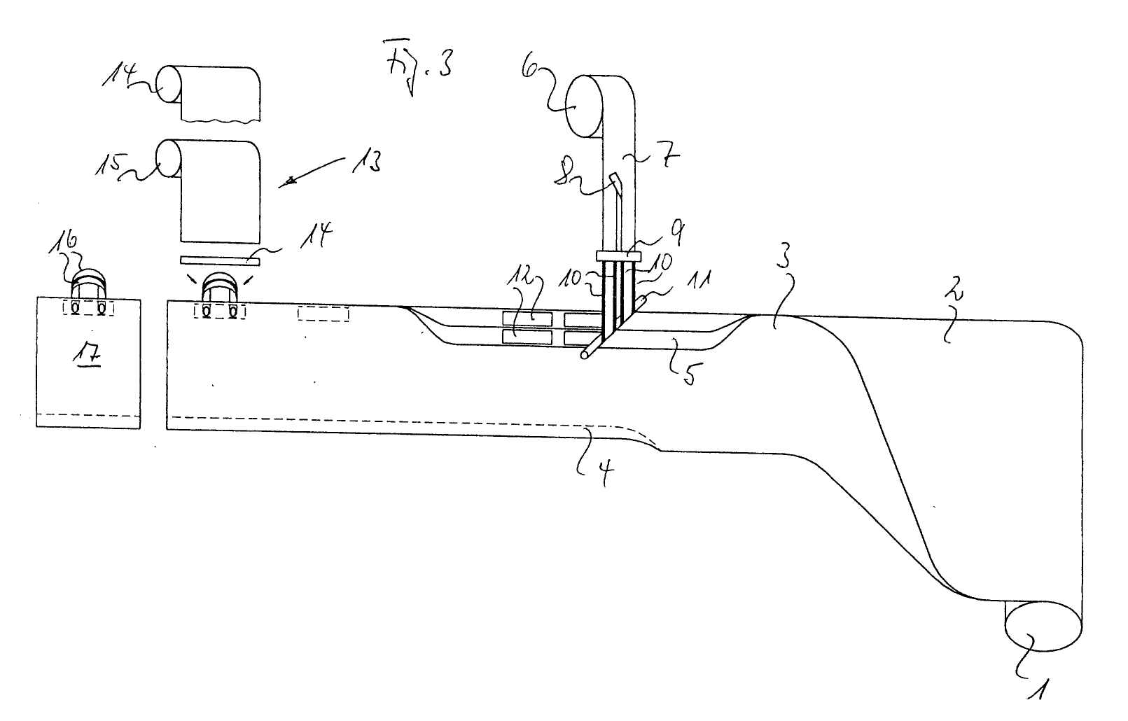

FIG. 2 a section through the welding area of two loop handle shanks that are positioned on top of each other along the line II-II in FIG. 1,

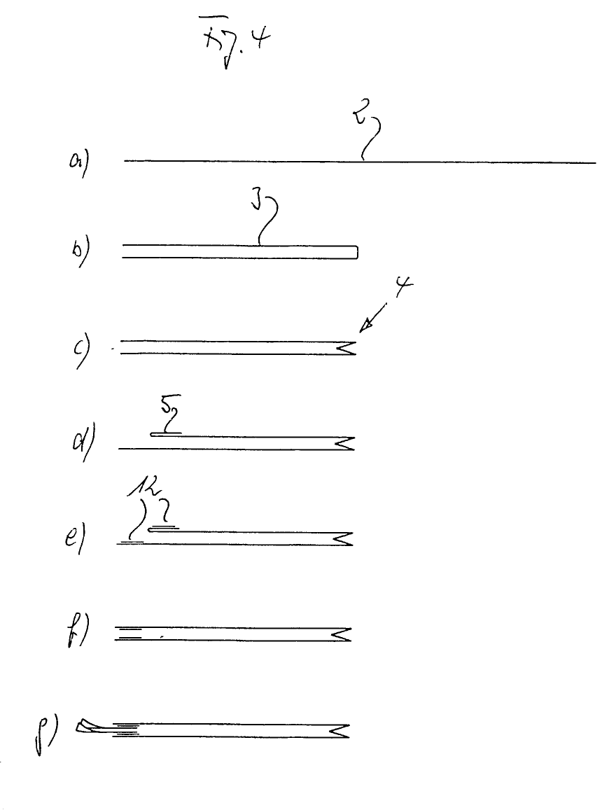

FIG. 3 a sketched illustration of the inventive production method, and

FIGS. 4a-f the separate steps of the inventive method for producing loop handle shopping bags in the shape of cross sections through the foil sheeting, semi-tube sheeting, and loop handle shopping bag according to FIG. 3.

Based on FIG. 3 and FIG. 4, a flat foil sheeting 2 consisting of thermoplastic plastic is pulled off of a not illustrated foil roll 1 held by an unwind rack by means of not illustrated pull-off devices. This flat foil sheeting is illustrated in FIG. 4a in a cross section.

This flat foil sheeting is then folded in the center into the shape of a semi-tube sheeting 3 by means of a not illustrated, known device, as is shown in a sectional view in FIG. 4b. In a subsequent processing station, a bottom fold 4 is placed into this semi-tube sheeting, as is shown in FIG. 4c. The edge area 5 of the upper layer is then folded back onto itself, as is shown in FIG. 4d from the semi-tube sheeting that is continuously or intermittently pulled forward so that the interior edge areas of the semi-tube sheeting are exposed.

A plastic sheeting 7 is pulled off of the foil roll 6 consisting of weld-friendly thermoplastic plastic in the manner shown in FIG. 3, which is separated by means of a separating knife 8 into two equally wide sheets that are positioned on one level. Both of these sheets are equipped with adhesive applications 10, such as hot melt applications, at their edges in a station 9. The sheets glued in this way are then redirected via a rod 11 onto the level of the exposed edge areas. The reinforcement warps 12 are then separated in pairs from the glued sheets in a manner shown in FIG. 4e and pressed onto the exposed interior edge areas of the semi-tube sheeting, each at a distance corresponding to the width of the loop handle shopping bags to be produced. After the reinforcement warps have been glued onto the interior edge areas of the semi-tube sheeting, the upper edge area 5 is folded back as shown in FIG. 4f so that the reinforcement warps are congruently placed back-to-back, each in the center of the loop handle shopping bags that will be separated later.

In station 13, plastic sheeting is removed from two rolls 14, 15 consisting of thermoplastic plastic that are positioned behind each other, from which handle strips 14 that are positioned back-to-back are separated. These handle strips 14 are shaped into U-shaped loop handles 16 as they are positioned back-to-back. The free ends of these loop handles are then inserted between the reinforcement warps 12 that are positioned back-to-back, and welded together with the reinforcement warps, and above the same with the edge areas of the semi-tube sheeting 3 by means of weld seams, preferably O-shaped weld seams.

The finished loop handle bags 17 are then weld-separated from the semi-tube sheeting connected by loop handles by means of lateral weld separating seams in the described manner. The preferably O-shaped weld seams 18 are performed in the manner shown in FIG. 2 so that they will connect the free ends of the loop handle 16 shanks with the edge areas of the semi-tube sheeting by interpositioning the reinforcement warps 12 consisting of a particularly weld-friendly material. However, the welding of the loop handles with the warps only can also be sufficient.

In order to avoid a welding of the back-to-back positioned loop handle shanks with each other, they are equipped with a separating layer, or a separating place, or a heatable crimper embodied as an abutment is inserted between them during welding.

1. Method for producing loop handle shopping bags (17) based on a semi-tube sheeting (3) consisting of thermoplastic plastic that is preferably equipped with a bottom fold (4),
in which at least one edge strip (5) of the semi-tube sheeting (3) is folded onto itself and attached to reinforcement warps (12) on the interior sides of the edge areas that consist of weld-friendly plastic by means of glueing or welding,
in which subsequently at least the one edge strip (5) is folded back so that the added reinforcement warps (12) are congruently positioned back-to-back,
in which double-layer handle strips (14) that are equipped with at least one layer preventing a weld between their back-to-back sides, or into which a plate, such as a separating plate, is inserted during welding, are positioned in a U-shape, and positioned between the reinforcement warps (12) with their end areas of their free shanks, and welded
together with the edge areas between weld devices through the reinforcement warps (12), and
in which the shopping bags (17) are separated from the semi-tube sheeting (3) by means of separating weld seams, or weld seams and separating cuts.

2. Method according to claim 1, characterized that at least the weld zones (18) remain free of adhesive during the attachment of the reinforcement warps (12).

3. Method according to claims 1 or 2, characterized that the handle strips (14) are welded together in a welding process both with the reinforcement warps (12) and with the edge areas of the shopping bags.

4. Method according to claim 3, characterized that the welding of the handle strips (14) with the edge areas of the shopping bags occurs through the reinforcement warps.

5. Loop handle shopping bag, consisting of a semi-tube section made of thermoplastic plastic that is preferably equipped with a bottom fold, the side edges of which are closed by means of weld seams, and consisting of handle shanks of plastic foil strips (14) folded into U-shaped loops that are welded onto the interior sides of the edge areas at the opening side,
characterized that reinforcement warps (12) consisting of weld-friendly plastic are attached to the center areas on the interior sides of the edge areas that have been welded together with the handle shanks.
